(19) United States
(12) Patent Application Publication
(10) Pub. No.: US 2013/0146658 A1
(43) Pub. Date: Jun. 13, 2013

(54) Medical Insurance Card With Quick Response Code System

(71) Applicant: Geraldo Leonel Guerra, Mission, TX (US)

(72) Inventor: Geraldo Leonel Guerra, Mission, TX (US)

(21) Appl. No.: 13/323,651

(22) Filed: Dec. 12, 2011

(51) Int. Cl. G06F 17/00

(52) U.S. Cl. 235/380

(57) ABSTRACT

The present invention is a system with a medical insurance card with one or more quick response code images that includes an electronic device that includes an output device, an input device that scans a plurality of file types displayed on the output device of the electronic device utilized by the system and an insurance card with a front facing and a back facing used to identify a user to use or obtain services or benefits from a healthcare insurance company, a healthcare plan type or is used as part of or all of one or more vision, dental, or hearing or related health services. The one or more quick response code images that are disposed on the insurance card and is scanned or photographed by the electronic device that include a plurality of file types.

### TECHNICAL FIELD & BACKGROUND

The present invention generally relates to a medical insurance card. More specifically, the invention is a medical insurance card that is integrated into a quick response or a QR code system.

It is an object of the invention to provide a medical insurance card that is integrated into a quick response or a QR code system.

It is an object of the invention to provide a medical insurance card that is integrated into a quick response or a QR code system where a user utilizes a cell phone camera, a tablet camera, an IPAD™ or an IPOD™ camera, a computer camera or any suitable electronic device used to scan a QR code image to open a web page or one or more file types on the scanning electronic device's browser.

It is an object of the invention to provide a medical insurance card that is integrated into a quick response or QR code system that allows an insurance company to simplify the function and use of information to a health care provider and their insured members.

What is really needed is a medical insurance card that is integrated into a quick response or a QR code system where a user utilizes a cell phone camera, a tablet camera, an IPAD™ or an IPOD™ camera, a computer camera or any suitable electronic device used to scan or obtain a QR code image to open a web page or one or more file types on the scanning electronic device's browser that allows an insurance company to simplify the function and use of information to a health care provider and their insured members.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a block diagram of a system for a medical insurance card with one or more quick response code images, in accordance with one embodiment of the present invention.

FIG. 2A illustrates a front view of a medical insurance card with one or more quick response code images, in accordance with one embodiment of the present invention.

FIG. 2B illustrates a rear view of a medical insurance card with one or more quick response code images, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

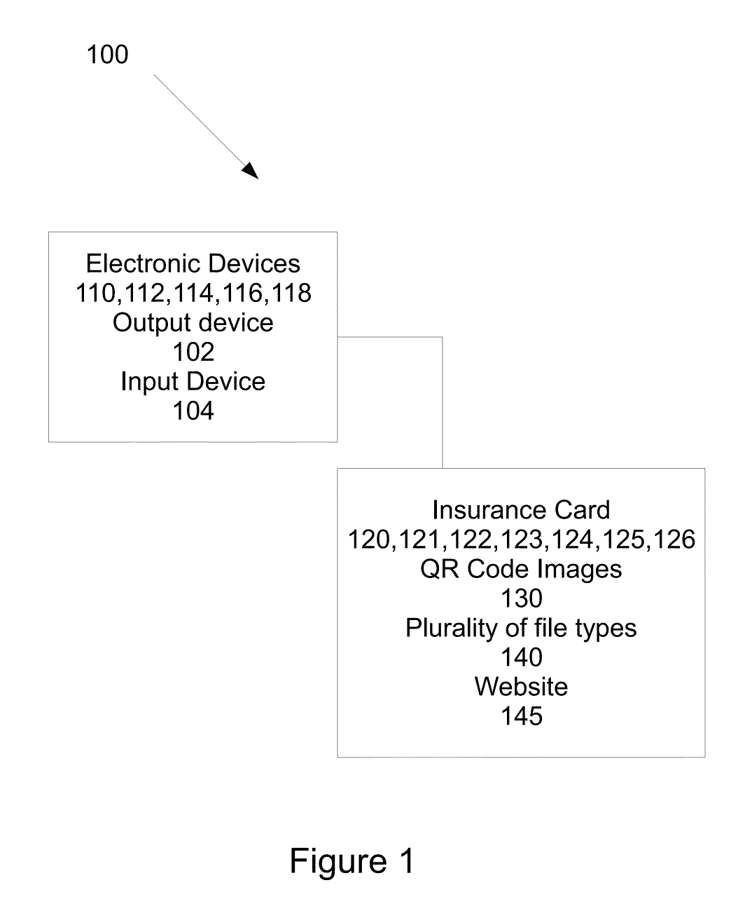

FIG. 1 illustrates a block diagram of a system 100 of a medical insurance card with one or more quick response code images, in accordance with one embodiment of the present invention.

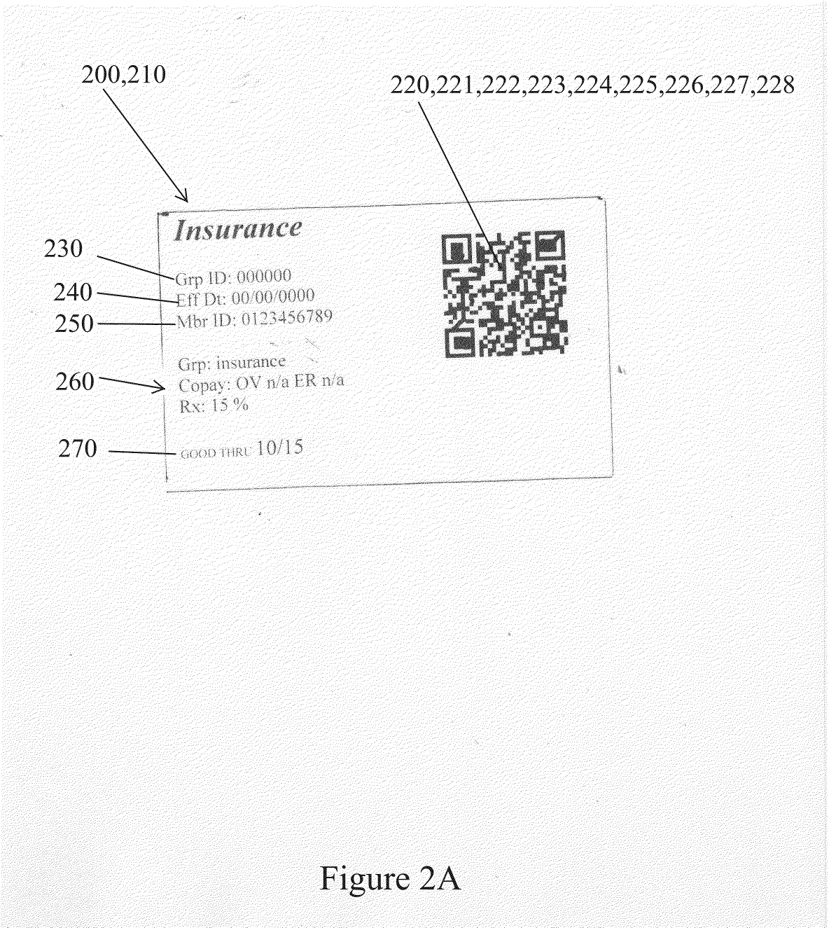

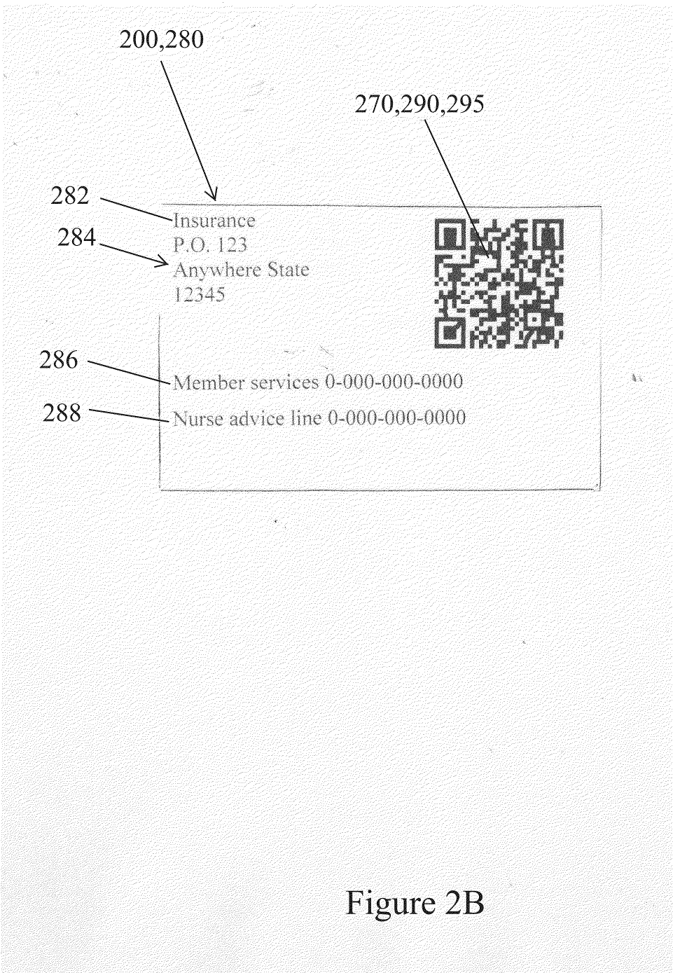

The system 100 includes an electronic device 110, an insurance card 120, one or more quick response or QR code images 130 and a plurality of file types 140. The electronic device 110 includes an output device 102, an input device 104 that scans the plurality of file types 140 typically displayed on the output device 112 of the electronic device 110 utilized by the system 100. The electronic device 110 can be a cell phone camera 112, a tablet camera 114, an IPAD™ or an IPOD™ camera 116, a computer camera 118 or any suitable electronic device used to scan or obtain the QR code images 130. The insurance card 120 has a front facing 121, a back facing 122 and is typically an identification card 123 that is typically an insurance card 124, an insurance plan or coverage card 125, a membership card 126 or any card or document used to identify a user to use or obtain services or benefits from a healthcare insurance company, or healthcare plan type or is used as part of or all of one or more vision, dental, or hearing or related health services. The QR code image 130 is disposed on the ID card 120 and is scanned or photographed by the electronic device 110. The one or more quick response or QR code images 130 can be disposed exclusively on the front facing 121, exclusively on the back facing 122 or disposed simultaneously on both the front facing 121 and the back facing 122. The one or more quick response or QR code images 130 include a one or more QR file types 140 that can reside on a website 145 that are described and illustrated in greater length in the subsequent FIG. 2A and FIG. 2B descriptions and illustrations. Additional details regarding the system 100 and the electronic device 110, the insurance card 120 and one or more quick response or QR code images 130 are described in FIGS. 2A and FIG. 2B.

FIG. 2A illustrates a front view of a medical insurance card 200 with one or more quick response code images, in accordance with one embodiment of the present invention.

The medical insurance card 200 includes a front facing 210 which is illustrated in FIG. 2A. The front facing 210 can include the one or more QR code images 220, a group identification number 230, an effective date 240, a member identification number 250, one or more pieces of co-payment information 260 and an expiration date 270.

The one or more QR code images 220 are similar to the same QR code images (FIG. 1, 130) described in FIG. 1 and its description and can be disposed on or optionally disposed on the front facing 210 of the medical insurance card 200. The one or more QR code images 220 are selected from the group consisting of any combination of QR code types of a numeric encoding 221, an alphanumeric encoding 222, a byte encoding 223, a Kanji encoding 224, a structured append 225, an extended channel interpretation 226, a FNC1 in a first position 227 or a FNC1 in a second position 228. The QR code types (FIG. 1, 140) are similar to the same QR code images (FIG. 1, 130) previously described in FIG. 1 and its description and illustration.

The numeric encoding 221 can be 10 bits per 3 digits or any other suitable numeric encoding quantity, the alphanumeric encoding 222 can be 11 bits per 2 characters or any other suitable alphanumeric encoding and a byte encoding of 8 bits per character 223 or any other suitable byte encoding or quantity. The Kanji encoding 224 can be 13 bits per character, although the Kanji encoding 224 can be any suitable type of or quantity of Kanji encoding, the structured append 225 which can be used to split a message across multiple QR symbols 226 can also be an extended channel interpretation 229 that can select one or more alternate character set or encoding and can be any suitable type of or quantity of structured append, a FNC1 can be in a first position 227 or can be any suitable type of or quantity of FNC1 and a FNC1 can be in a second position 228 or can be any suitable type of or quantity of FNC1.

The group identification number 230 typically corresponds to the user of the medical insurance card 200 and can be any suitable combination of numbers, symbols, letters or other suitable characters that are distinctive to only that user in the system 100. The effective date 240 is the effective date of the user's medical insurance card 200 and can be any suitable combination of numbers, symbols, letters or other suitable characters. The member identification number 250 can be any suitable combination of numbers, symbols, letters or other suitable characters. The one or more pieces of co-payment information 260 and can be any suitable combination of numbers, symbols, letters, one or more percentages or other suitable characters. The expiration date 270 is a date that the medical insurance card 200 will expire and can be in any suitable combination of numbers, symbols or letters.

FIG. 2B illustrates a rear view of a medical insurance card 200 with one or more quick response code images, in accordance with one embodiment of the present invention. The medical insurance card 200 includes a rear facing 280 which is illustrated in FIG. 2B. The rear facing 280 can optionally have one or more QR code images 290 (FIG. 1, 130) disposed on the rear facing 280, or one or more quick response or QR code file types 270 (FIG. 1, 140) or have a rear facing 280 without have one or more QR code images 290 (FIG. 1, 130) disposed on the rear facing 280, or one or more quick response or QR code file types 295 (FIG. 1, 140).

The rear facing 280 includes a user's name 282, a user's address 284, a member services number 286 and a nurse advice telephone number 288. The user's name 282 can be in any suitable language with any suitable characters such as alpha numeric letters and numbers that indicate the user's name. The user's address 284 can be in any suitable language with any suitable characters such as alpha numeric letters and numbers that indicate the user's address. The member services number 286 can be in any suitable language with any suitable characters such as alpha numeric letters and numbers that indicate the user's member services number. The nurse advice telephone number 288 can be in any suitable language with any suitable characters such as one or more alpha numeric numbers and symbols that indicate the user's member services number.

The medical insurance card is integrated into a quick response or a QR code system where a user utilizes an electronic device such as a cell phone camera, a tablet camera, an IPAD™ or an IPOD™ camera, a computer camera or any suitable electronic device used to scan or obtain a QR code image to open a web page or one or more file types on the scanning electronic device's browser that allows insurance companies to simplify the function and use of information to a health care provider and their insured members.

A health care provider is an individual or an institution that provides preventive, curative, promotional or rehabilitative health care services in a systematic way to individuals, families or communities. An individual health care provider (also known as a health worker) may be a health care professional, an allied health professional, a community health worker, or another person trained and knowledgeable in medicine, nursing or other allied health professions, or public/community health. Institutions (also known as health facilities) include hospitals, clinics, primary care centers and other service delivery points. The practice of health professionals and operation of health care institutions is typically regulated by national or state/provincial authorities through appropriate regulatory bodies for purposes of quality assurance. Together, they form part of an overall health care system. Including DME, Vision, Dental, Hearing, Pharmacy, Laboratory, Imaging center or any other health care provider contracted with the health plan.

The system, webpage or plurality of files will not have personal information and will not violate (HIPAA) Health Insurance Portability and Accountability Act of 1996 guidelines. The QR code will be used by insurance companies to simplify the function of information to health care providers and their insured members. A health care provider's office employee will scan the QR code for information like (plans terms and conditions or a member's co-payments, forms to be printed for use, contact information or anything else an insurance company wishes to publish on their website or file type). A doctor's office may also need to log into the website (after scanning the image of the QR code) to retrieve a verification or discount code for service. A member or an insured person may scan the QR code for information like (provider directory, plan benefits, drug formulary, co-payments, pharmacy network, contact information and anything else) an insurance company wishes to publish on their website or file type.

The term health insurance is used to describe any program that helps pay for medical expenses, whether through privately purchased insurance, social insurance or a non-insurance social welfare program funded by the government. Synonyms for this usage include “health coverage,” “health care coverage” and “health benefits.” which would also include including (HMO, PPO, PFFS) plans.

The following is a listing of a plurality of file types for a webpage:

### Static

dtd, Document Type Definition (standard), MUST be public and free
RNA—(.rna)—lime Network Real Native Application File
XML—(.xml) —eXtensible Markup Language
HTML —(.html, .htm)—HyperText Markup Language
XHTML—(.xhtml, .xht)—eXtensible HyperText Markup Language
MHTML —(.mht, .mhtml)—Archived HTML, store all data on one web page (text, images, etc.) in one big file

### Dynamically Generated

ASP—(.asp)—Microsoft Active Server Page
ASPX—(.aspx)—Microsoft Active Server Page. NET
ADP—AOLserver Dynamic Page
BML—(.bml)—Better Markup Language (templating)
CFM—(.cfm)—ColdFusion
CGI—(.cgi)
iHTML—(.ihtml)—Inline HTML
JSP—(.jsp) JavaServer Pages
Lasso—(.las, .lasso, .lassoapp)
PL—Perl (.pl)
PHP—(.php, .php?, .phtml) —? is version number (previously abbreviated Personal Home Page, later changed to PHP: Hypertext Preprocessor)
SSI—(.shtml)—HTML with Server Side Includes (Apache)
SSI—(.stm)—HTML with Server Side Includes (Apache)

The following is a listing of a plurality of file types for a video:
AAF—mostly intended to hold edit decisions and rendering information, but can also contain compressed media essence
3GP—the most common video format for cell phones
GIF—Animated GIF (simple animation; until recently often avoided because of patent problems)
ASF—container (enables any form of compression to be used; MPEG-4 is common; video in ASF-containers is also called Windows Media Video (WMV))
AVCHD—Advanced Video Codec High Definition
AVI—container (a shell, which enables any form of compression to be used)
CAM—aMSN webcam log file
DAT—video standard data file (automatically created when we attempted to burn as video file on the CD)
DSH
FLV—Flash video (encoded to run in a flash animation)
M1V MPEG-1—Video
M2V MPEG-2—Video
FLA—Macromedia Flash (for producing)
FLR—(text file which contains scripts extracted from SWF by a free ActionScript decompiler named FLARE)
SOL—Adobe Flash shared object (“Flash cookie”)
M4V—(file format for videos for iPods and PlayStation Portables developed by Apple)
Matroska (*.mkv)—Matroska is a container format, which enables any video format such as MPEG-4 ASP or AVC to be used along with other content such as subtitles and detailed meta information
WRAP—MediaForge (*.wrap)
MNG—mainly simple animation containing PNG and JPEG objects, often somewhat more complex than animated GIF
QuickTime (.mov)—container which enables any form of compression to be used; Sorenson codec is the most common; QTCH is the filetype for cached video and audio streams
MPEG (.mpeg, .mpg, .mpe)
MPEG-4 Part 14, shortened “MP4”—multimedia container (most often used for Sony's PlayStation Portable and Apple's iPod)
MXF—Material Exchange Format (standardized wrapper format for audio/visual material developed by SMPTE)
ROQ—used by Quake 3
NSV—Nullsoft Streaming Video (media container designed for streaming video content over the Internet)
Ogg—container, multimedia
RM—RealMedia
SVI—Samsung video format for portable players
SMI—SAMI Caption file (HTML like subtitle for movie files)
SWF—Macromedia Flash (for viewing)
WMV—Windows Media Video

The following is a listing of a plurality of file types for a spreadsheet:
123—Lotus 1-2-3
AWS—Ability Spreadsheet
CLF—ThinkFree Calc
CELL—Haansoft(Hancom) SpreadSheet software document
CSV—Comma-Separated Values
numbers—An Apple Numbers Spreadsheet file
gnumeric—Gnumeric spreadsheet, a gziped XML file
ODS—Open Document spreadsheet
OTS—Open Document spreadsheet template
QPW—Quattro Pro spreadsheet
SDC—StarOffice StarCalc Spreadsheet
SLK—SYLK (SYmbolic LinK)
STC—OpenOffice.org XML (obsolete) Spreadsheet template
SXC—OpenOffice.org XML (obsolete) Spreadsheet
TAB—tab delimited columns; also TSV (Tab-Separated Values)
TXT—tab delimited columns
VC—Visicalc
WK1—Lotus 1-2-3 up to version 2.01
WK3—Lotus 1-2-3 version 3.0
WK4—Lotus 1-2-3 version 4.0
WKS—Lotus 1-2-3
WKS—Microsoft Works
WQ1—Quattro Pro DOS version
XLK—Microsoft Excel worksheet backup
XLS—Microsoft Excel worksheet sheet (97-2003)
XLSB—Microsoft Excel binary workbook
XLSM—Microsoft Excel Macro-enabled workbook
XLSX—Office Open XML worksheet sheet
XLR—Microsoft Works version 6.0
XLT—Microsoft Excel worksheet template
XLTM—Microsoft Excel Macro-enabled worksheet template
XLW—Microsoft Excel worksheet workspace (version 4.0)

The following is a listing of a plurality of file types for sound and music:
Uncompressed
   AIFF—Audio Interchange File Format
   AU
   CDDA
   IFF-8SVX
   IFF-16SV
   RAW—raw samples without any header or sync
   WAV—Microsoft Wave
Compressed
   FLAC—(free lossless codec of the Ogg project)
   LA—Lossless Audio (.la)
   PAC—LPAC (.pac)
   M4A—Apple Lossless (M4A)
   APE—Monkey's Audio (APE)
   OptimFROG
   RKA—RKAU (.rka)
   SHN—Shorten (SHN)
   TTA—free lossless audio codec (True Audio)
   WV—WavPack (.wv)
   WMA—Windows Media Audio 9 Lossless (WMA)
      [edit] Lossy Audio
AMR—for GSM and UMTS based mobile phones
MP2—MPEG Layer 2
MP3—MPEG Layer 3
Speex—Ogg project, specialized for voice, low bitrates
GSM—GSM Full Rate, originally developed for use in mobile phones
WMA—Windows Media Audio (.WMA)
AAC (.m4a, .mp4, .m4p, .aac)—Advanced Audio Coding (usually in an MPEG-4 container)
MPC—Musepack
VQF—Yamaha TwinVQ
RealAudio (RA, RM)
OTS—Audio File (similar to MP3, with more data stored in the file and slightly better compression; designed for use with OtsLabs' OtsAV)
SWA—Macromedia Shockwave Audio (Same compression as MP3 with additional header information specific to Macromedia Director
VOX—Dialogic ADPCM Low Sample Rate Digitized Voice (VOX)
VOC—Creative Labs Soundblaster Creative Voice 8-bit & 16-bit (VOC)
DWD—DiamondWare Digitized (DWD)
SMP—Turtlebeach SampleVision (SMP)

The following is a listing of a plurality of file types for Script AHK-AutoHotley script file:
APPLESCRIPT—See SCPT.
AS—Adobe Flash ActionScript File
AU3—Autolt version 3
BAT—Batch file
BAS—QBasic & QuickBASIC
CMD—Batch file
Coffee—CoffeeScript
EGG—Chicken
EGT—EGT Asterisk Application Source File, EGT Universal Document
ERB—Embedded Ruby
HTA—HTML Application
IBI—Icarus script
ICI—ICI
ITCL—Itcl
JS‘JavaScript and JScript
JSFL—Adobe JavaScript language
LUA—Lua
M—Mathematica package file
MRC—mIRC Script
NCF—NetWare Command File (scripting for Novell's NetWare OS)
NUT—Squirrel
PHP—PHP
PHP?—PHP (?=version number)
PL—Perl
PM—Perl module
PS1—Windows PowerShell shell script
PS1XML—Windows PowerShell format and type definitions
PSC1—Windows PowerShell console file
PSD1—Windows PowerShell data file
PSM1—Windows PowerShell module file
PY—Python
PYC—Python
PYO—Python
R—R scripts
RB—Ruby
RDP—RDP connection
SCPT—Applescript
SCPTD—See SCPT.
SDL—State Description Language
SH—Shell script
TCL—Tcl
VBS—Visual Basic Script
XPL—XProc script/pipeline
ebuild—Gentoo linux's portage package.

The following is a listing of a plurality of file types for a presentation:
KEY, KEYNOTE—Apple Keynote Presentation
NB—Mathematica Slideshow
NBP—Mathematica Player slideshow
ODP—Open Document Presentation
OTP—Open Document Presentation template
POT—Microsoft PowerPoint template
PPS—Microsoft PowerPoint Show
PPT—Microsoft PowerPoint Presentation
PPTX—Office Open XML Presentation
PRZ—Lotus Freelance Graphics
SDD—StarOffice's Starlmpress
SHF—ThinkFree Show
SHOW—Haansoft(Hancom) Presentation software document
SHW—Corel Presentations slide show creation
SLP—Logix-4D Manager Show Control Project
SSPSS—SongShow Plus Slide Show
STI—OpenOffice.org XML (obsolete) Presentation template
SXI—OpenOffice.org XML (obsolete) Presentation
WATCH—Dataton Watchout Presentation

The following is a listing of a plurality of file types for a raster graphics:

Raster (or Bitmap) files store images as a group of pixels.
ASE—Adobe Swatch
ART—America Online proprietary format
BMP—Microsoft Windows Bitmap formatted image
BLP—Blizzard Entertainment proprietary texture format
CIT—Intergraph is a monochrome bitmap format
CPT—Corel PHOTO-PAINT image
CUT—Dr. Halo image file
DDS—DirectX texture file
DIB—Device-Independent Bitmap graphic
DjVu—DjVu for scanned documents
EGT—EGT Universal Document, used in EGT SmartSense to compress PNG files to yet a smaller file
Exif—Exchangeable image file format (Exif) is a specification for the image file format used by digital cameras
GIF—CompuServe's Graphics Interchange Format
GPL—GIMP Palette, using a textual representation of color names and RGB values
ICNS—file format use for icons in Mac OS X. Contains bitmap images at multiple resolutions and bit depths with alpha channel.
ICO—a file format used for icons in Microsoft Windows. Contains small bitmap images at multiple resolutions and sizes.
IFF (.iff, .ilbm, .Ibm)—ILBM
JNG—a single-frame MNG using JPEG compression and possibly an alpha channel.
JPEG, JFIF (.jpg or .jpeg)—Joint Photographic Experts Group—a lossy image format widely used to display photographic images.
JP2—JPEG2000
JPS—JPEG Stereo
LBM—Deluxe Paint image file
MAX—ScanSoft PaperPort document
MIFF—ImageMagick's native file format
MNG—Multiple Network Graphics, the animated version of PNG
MSP—a file format used by old versions of Microsoft Paint. Replaced with BMP in Microsoft Windows 3.0
NITF—A U.S. Government standard commonly used in Intelligence systems
OTA bitmap (Over The Air bitmap)—a specification designed by Nokia for black and white images for mobile phones
PBM—Portable bitmap
PC1—Low resolution, compressed Degas picture file
PC2—Medium resolution, compressed Degas picture file
PC3—High resolution, compressed Degas picture file
PCF—Pixel Coordination Format
PCX—a lossless format used by ZSoft's PC Paint, popular at one time on DOS systems.
PDN—Paint.NET image file
PGM—Portable graymap
PI1—Low resolution, uncompressed Degas picture file
PI2—Medium resolution, uncompressed Degas picture file. Also Portrait Innovations encrypted image format.
PI3—High resolution, uncompressed Degas picture file
PICT, PCT—Apple Macintosh PICT image
PNG—Portable Network Graphic (lossless, recommended for display and edition of graphic images)
PNM—Portable anymap graphic bitmap image
PNS—PNS—PNG Stereo
PPM—Portable Pixmap (Pixel Map) image
PSB—Adobe Photoshop Big image file (for large files)
PSD, PDD—Adobe Photoshop Drawing
PSP—Paint Shop Pro image
PX—Pixel image editor image file
PXR—Pixar Image Computer image file
QFX—QuickLink Fax image
RAW—General term for minimally processed image data (acquired by a digital camera)
RLE—a run-length encoded image
SCT—Scitex Continuous Tone image file
SGI, RGB, INT, BW—Silicon Graphics Image
TGA (.tga, .targa, .icb, .vda, .vst, .pix)—Truevision TGA (Targa) image
TIFF (.tif or .tiff)—Tagged Image File Format (usually lossless, but many variants exist, including lossy ones)
TIFF/EP (.tif or .tiff)—ISO 12234-2; tends to be used as a basis for other formats rather than in its own right.
XBM—X Window System Bitmap
XCF—GIMP image (from Gimp's origin at the experimental Computing Facility of the University of California)
XPM—X Window System Pixmap

The following is a listing of a plurality of file types for a list of archive formats:
.?Q?—files compressed by the SQ program.
7z—7-Zip compressed file
AAC—Advanced Audio Coding
ace—ACE compressed file
ALZ—ALZip compressed file
AT3—Sony's UMD Data compression
.bke—BackupEarth.com Data compression
ARC
ARJ—ARJ compressed file
BA—Scifer Archive (.ba), Scifer External Archive Type
big—Special file compression format used by Electronic Arts for compressing the data for many of EA's games
BIK (.bik)—Bink Video file. A video compression system developed by RAD Game Tools
BKF (.bkf)—Microsoft backup created by NTBACKUP.EXE
bzip2—(.bz2)
bmp—(paint)
c4—JEDMICS image files, a DOD system
cab—Microsoft Cabinet
cals—JEDMICS image files, a DOD system
cpt/sea—Compact Pro (Macintosh)
DAA—Closed-format, Windows-only compressed disk image
deb—Debian Linux install package
DMG—an Apple compressed/encrypted format
EEA—An encrypted CAB, ostensibly for protecting email attachments
.egg—Alzip Egg Edition compressed file
EGT (.egt)—EGT Universal Document also used to create compressed cabinet files replaces .ecab
ECAB (.ECAB, .ezip)—EGT Compressed Folder used in advanced systems to compress entire system folders, replaced by EGT Universal Document
ESS (.ess)—EGT SmartSense File, detects files compressed using the EGT compression system.
GHO (.gho, .ghs)—Norton Ghost
gzip (.gz)—Compressed file
IPG (.ipg)—Format in which Apple Inc. packages their iPod games. can be extracted through Winrar
jar—ZIP file with manifest for use with Java applications.
LBR—Library file
LQR—LBR Library file compressed by the SQ program.
LHA (.lzh)—Lempel, Ziv, Huffman
Izo
Izma
LZX (algorithm)
MBRWizard archive (.mbw)
MPQ Archives (.mpq)—Used by Blizzard games
MacBinary (.bin)
NTH (.nth)—Nokia Theme Used by Nokia Series 40 Cellphones
PAK—Enhanced type of .ARC archive
Parchive (.par, .par2)
Quake 3 archive (.pk3)—(See note on Doom³)
Doom³ archive (.pk4)—(Opens similarly to a zip archive.)
RAR Rar Archive (.rar)—for multiple file archive (rar to .r01-.r99 to s01 and so on)
SEN Scifer Archive (.sen)—Scifer Internal Archive Type
sit/sitx—Stufflt (Macintosh)
tar
.tar.gz, .tgz—gzipped tar file
TB (.tb)—Tabbery Virtual Desktop Tab file
TIB (.tib)—Acronis True Image backup
uha—Ultra High Archive Compression
VIV—Archive format used to compress data for several video games, including Need For Speed: High Stakes.
VOL—unknown archive
VSA—Altiris Virtual Software Archive
WAX—Wavexpress—A ZIP alternative optimized for packages containing video, allowing multiple packaged files to be all-or-none delivered with near-instantaneous unpacking via NTFS file system manipulation.
Z—Unix compress file
zoo
zip

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system with a medical insurance card with one or more quick response code images, comprising:
an electronic device that includes an output device, an input device that scans a plurality of file types displayed on said output device of said electronic device utilized by said system;
an insurance card with a front facing and a back facing used to identify a user to use or obtain services or benefits from a healthcare insurance company, a healthcare plan type or is used as part of or all of one or more vision, dental, or hearing or related health services;
wherein said one or more quick response code images that are disposed on said insurance card and is scanned or photographed by said electronic device that include a plurality of file types.

2. The system according to claim 1, wherein said electronic device is selected from the group consisting of a cell phone camera, a tablet camera or a computer camera.

3. The system according to claim 1, wherein said electronic device is used to scan or obtain said QR code images.

4. The system according to claim 1, wherein said insurance card is selected from the group that consists of an identification card, an insurance card, an insurance plan, a coverage card or a membership card.

5. The system according to claim 1, wherein said front facing includes said one or more QR code images, a group identification number, an effective date, a member identification number, one or more pieces of co-payment information and an expiration date.

6. The system according to claim 1, wherein said rear facing includes a user's name, a user's address, a member services number and a nurse advice telephone number.

7. The system according to claim 1, wherein said one or more quick response code images include one or more QR file types that reside on a website.

8. The system according to claim 1, wherein said one or more quick response code images are disposed exclusively on said back facing.

9. The system according to claim 1, wherein said one or more quick response code images are disposed exclusively on said front facing.

10. The system according to claim 1, wherein said one or more quick response code images are disposed simultaneously on both said front facing and said back facing.

11. The system according to claim 1, wherein said one or more QR code images are selected from the group consisting of any combination of QR code types of a numeric encoding, an alphanumeric encoding, a byte encoding, a Kanji encoding, a structured append, an extended channel interpretation, a FNC1 in a first position or a FNC1 in a second position.

12. A medical insurance card with one or more quick response code images, comprising:
an electronic device that includes an output device, an input device that scans a plurality of file types displayed on said output device of said electronic device utilized by said system;
wherein said insurance card includes a front facing and a back facing used to identify a user to use or obtain services or benefits from a healthcare insurance company, a healthcare plan type or is used as part of or all of one or more vision, dental, or hearing or related health services;
wherein said one or more quick response code images that are disposed on said insurance card and is scanned or photographed by said electronic device that include a plurality of file types.

13. The system according to claim 12, wherein said electronic device is selected from the group consisting of a cell phone camera, a tablet camera or a computer camera.

14. The system according to claim 12, wherein said electronic device is used to scan or obtain said QR code images.

15. The system according to claim 12, wherein said insurance card is selected from the group that consists of an identification card, an insurance card, an insurance plan, a coverage card or a membership card.

16. The system according to claim 12, wherein said front facing includes said one or more QR code images, a group identification number, an effective date, a member identification number, one or more pieces of co-payment information and an expiration date.

17. The system according to claim 12, wherein said rear facing includes a user's name, a user's address, a member services number and a nurse advice telephone number.

18. The system according to claim 12, wherein said one or more quick response code images include one or more QR file types that reside on a website.

19. The system according to claim 12, wherein said one or more quick response code images are disposed exclusively on said back facing, are disposed exclusively on said front facing or disposed simultaneously on both said front facing and said back facing.

20. The system according to claim 12, wherein said one or more QR code images are selected from the group consisting of any combination of QR code types of a numeric encoding, an alphanumeric encoding, a byte encoding, a Kanji encoding, a structured append, an extended channel interpretation, a FNC1 in a first position or a FNC1 in a second position.
